(19) United States
(12) Patent Application Publication
(10) Pub. No.: US 2026/0110325 A1
(43) Pub. Date: Apr. 23, 2026

(54) LIGHTWEIGHT CAPPED DECORATIVE FASTENER

(71) Applicant: MacLean-Fogg Company, Mundelein, IL (US)

(72) Inventors: Kenneth James RIMATZKI, Harrison Township, MI (US); Joseph VERLA, Bloomfield Hills, MI (US); Mark RAVES, Commerce Township, MI (US); Lee Richard MAYERS, Sterling Heights, MI (US)

(73) Assignee: MacLean-Fogg Company, Mundelein, IL (US)

(21) Appl. No.: 19/425,797

(22) Filed: Dec. 18, 2025

Related U.S. Application Data
(63) Continuation-in-part of application No. 18/728,829.
Application No. 18/728,829 is a continuation-in-part of application No. PCT/US2023/010127, filed on Jan. 4, 2023.
(60) Provisional application No. 63/296,422, filed on Jan. 4, 2022.
(60) Provisional application No. 63/315,434, filed on Mar. 1, 2022.
(60) Provisional application No. 63/735,582, filed on Dec. 18, 2024.

(51) Int. Cl. F16B 37/14; B60B 3/16

(52) U.S. Cl. CPC F16B 37/14; B60B 3/16; B60B 2900/111

(57) ABSTRACT

A lightweight fastener assembly with reduced weight and method is provided. The fastener assembly has a fastener body with a cap retention feature adjacent a first end and a threaded portion extending from a second end. A load bearing surface is configured to mate with a fastener seat on a wheel. A flange is formed adjacent a load bearing surface and having a diameter larger than the cap retention feature. A wrenching feature is formed between the cap retention feature and the second end and is configured to be engaged by a standard tool. A cap is secured to the cap retention feature on the fastener body and has upright contoured walls extending to a cap top. The cap is hollow in a capped region defined by the contoured walls and cap top beyond the first end of the fastener body.

### CROSS-REFERENCE TO RELATED APPLICATIONS

This application claims the benefit of U.S. provisional application Ser. No. 63/735,582 filed Dec. 18, 2024, and is a continuation-in-part of U.S. application Ser. No. 18/728,829 filed Jul. 12, 2024, which is the U.S. national phase of International Application No. PCT/US2023/014265 filed Mar. 1, 2023, which claims the benefit of U.S. provisional application Ser. No. 63/315,434 filed Mar. 1, 2022 and is a continuation-in-part of International Application No. PCT/US2023/010127 filed Jan. 4, 2023 which claims the benefit of U.S. provisional application Ser. No. 63/315,434 filed Mar. 1, 2022 and U.S. provisional application Ser. No. 63/296,422 filed Jan. 4, 2022, the disclosures of which are hereby incorporated in their entirety by reference herein.

### BACKGROUND

Typically, a polished stainless cap is pressed over the wrenching feature of the fastener body (nut or bolt, with or without washer), such as a HEX wrenching feature. Then the skirt of the cap is crimped around the flange of the fastener body. This gives the fastener its decorative appearance. Beyond decoration, the cap also prevents foreign substances from damaging the joint (i.e., water corrosion, road debris impacts). The carbon steel fastener body functions to solely fasten the joint.

### SUMMARY

According to at least one embodiment, a lightweight fastener assembly is provided having a fastener body and a cap. The fastener body has a cap retention feature adjacent a first end and a threaded portion extending from a second end. A load bearing surface is configured to mate with a fastener seat on a wheel. A flange is formed adjacent a load bearing surface and having a diameter larger than the cap retention feature. A wrenching feature is formed between the cap retention feature and the second end. The cap is secured to the cap retention feature on the fastener body and has upright contoured walls extending to a cap top. The cap is hollow in a capped region defined by the contoured walls and cap top beyond the first end of the fastener body.

In another embodiment, the wrenching feature is formed along the flange.

In another embodiment, the wrenching feature is configured to be engaged by a standard tool.

In another embodiment, the wrenching feature is formed between the flange and the cap retention feature.

In another embodiment, the cap has a diameter less than the wrenching feature.

In another embodiment, the cap does not cover the flange and spins freely about the fastener body when secured to the retention feature.

In another embodiment, the wrenching feature comprises a polygonal wrenching surface for engagement by a standard tool.

In another embodiment, the wrenching feature comprises a spline drive feature.

In another embodiment, the fastener body comprises a nut body and the threaded portion comprises an internal threaded opening extending from the second end.

In another embodiment, the internal threaded opening has an aperture that extends through the fastener body from the first end to the second end.

In another embodiment, the cap retention feature on the fastener body comprises a retention wall having a diameter less than the first end.

In another embodiment, the cap is secured to the fastener body with continuous crimp along a circumference of the retention wall.

In another embodiment, the retention wall further comprises an annular groove.

In another embodiment, the cap is pre-formed with an engagement feature and is secured to retention wall in the nut body with an interference fit.

According to at least one embodiment, a lightweight fastener assembly is provided having a fastener body and a cap. The fastener body has a cap retention feature adjacent a first end and a threaded portion at a second end. A wrenching surface is formed between the first end and the second end. The cap secured to the retention feature, wherein the cap is hollow in a capped region that extends beyond the first end of the fastener body.

In another embodiment, the fastener body has a flange formed adjacent a load bearing surface having a diameter larger than the cap retention feature.

In another embodiment, the cap does not cover the flange.

In another embodiment, the cap is circumferentially crimped to the fastener body along the retention feature.

In another embodiment, the cap has a diameter less than the wrenching feature.

In another embodiment, the cap spins freely about the fastener body when secured to the retention feature.

According to at least one embodiment, a method for forming a lightweight fastener body is provided. A fastener body is formed with a cap retention feature adjacent a first end and a threaded portion extending from a second end. A standard wrenching surface is formed between the cap retention feature and the second end. The method includes forming a cap. An engagement feature on the cap is secured to the retention feature on the fastener body. When secured, the cap does not cover a wrenching surface on the fastener body.

In another embodiment, the method includes forming the fastener body the wrenching surface being a greater diameter than the cap.

### BRIEF DESCRIPTION OF THE DRAWINGS

FIG. 1 illustrates a lightweight decorative fastener assembly according to one embodiment of the present application.

FIG. 2 illustrates a cross-section view through section 2-2 of the lightweight decorative fastener assembly in FIG. 1.

FIG. 3 illustrates a partial cross-section view of a full weight traditional fastener assembly.

FIG. 4 illustrates a lightweight decorative fastener assembly according to one embodiment of the present application.

FIG. 5 illustrates a cross-section view through section 5-5 of the lightweight decorative fastener assembly in FIG. 4.

FIG. 6 illustrates the fastener body of the lightweight decorative fastener assembly in FIG. 4.

FIG. 7 is a partial cross-section view through section 5-5 of the fastener body in FIG. 6.

FIG. 8 illustrates a perspective cross-section view through section 5-5 of the lightweight decorative fastener assembly in FIG. 4.

FIG. 9 illustrates a lightweight decorative fastener assembly according to one embodiment of the present application.

FIG. 10 illustrates a cross-section view through section 10-10 of the lightweight decorative fastener assembly in FIG. 9.

FIG. 11 illustrates a lightweight decorative fastener assembly according to one embodiment of the present application.

FIG. 12 illustrates a lightweight decorative fastener assembly according to one embodiment of the present application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

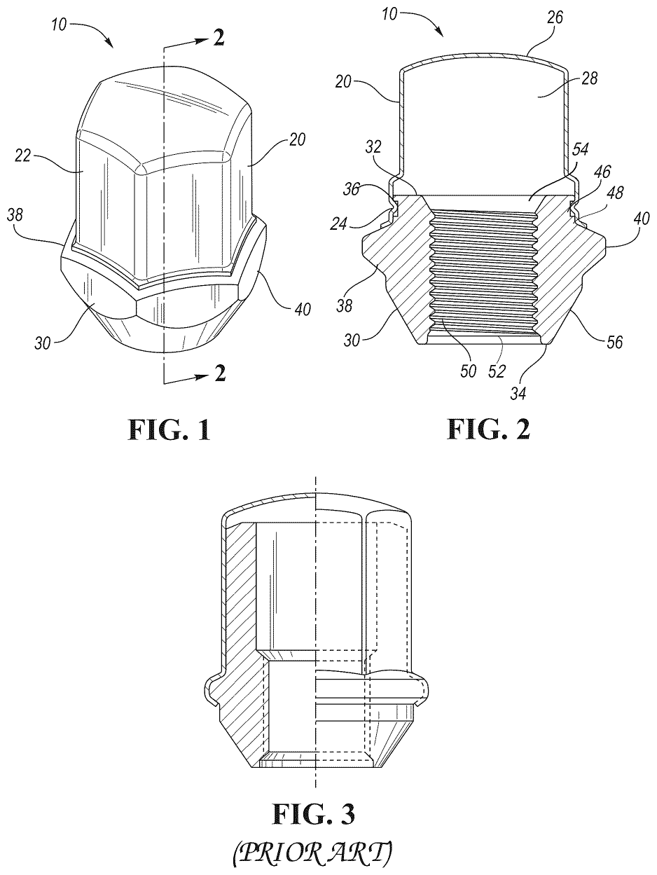

FIGS. 1 and 2 illustrate an embodiment of a lightweight wheel fastener assembly 10. The lightweight wheel fastener assembly 10 is configured to achieve a substantial reduction in overall mass relative to conventional decorative wheel fasteners, while maintaining required structural performance and an external appearance comparable to traditional designs. In the illustrated embodiment, the lightweight wheel fastener assembly 10 includes a decorative cap 20 secured to a fastener body 30. As shown, the fastener body 30 may be configured as a nut having an internally threaded portion. In alternative embodiments, the fastener body may be configured as a bolt having an externally threaded portion.

Conventional decorative wheel fasteners, such as those illustrated in FIG. 3, typically include a fastener body having a tool-engagement surface defining a geometry configured to be engaged by a standard wrench or installation tool. In such conventional designs, the tool-engagement surface of the fastener body is covered by a decorative cap that is crimped around a flange of the fastener body. The crimped cap itself defines the external wrenching surface, thereby requiring the cap structure to be capable of withstanding installation torque and remain secured to the fastener body.

In contrast, the lightweight wheel fastener assembly of the present disclosure significantly reduces fastener mass by decoupling the decorative cap from the primary load-bearing and wrenching functions of the fastener body. In particular, a cap retention feature is provided on the fastener body to secure the cap without requiring the cap to be crimped over a large flange. As a result, the decorative cap does not need to correspond to a wrenching surface, and the geometry of the cap is no longer constrained by the geometry of the wrenching feature. In certain embodiments, the flange associated with conventional designs may be reduced in size or eliminated entirely, further contributing to mass reduction while preserving structural integrity and desired aesthetics.

In embodiments of the present disclosure, the decorative cap is substantially hollow in a capped region extending beyond the fastener body, such that the cap defines an internal cavity rather than a solid mass. The hollow construction of the cap, in combination with the reduced structure of the fastener body, may provide weight savings in excess of 35% or more relative to traditional decorative wheel fasteners. By way of example, a conventional full-weight decorative fastener may have a mass of approximately 84 grams, whereas a lightweight fastener assembly in accordance with the present disclosure may have a mass of approximately 52 grams, or less. These values are provided for illustrative purposes and may vary depending on dimensions, and specific configurations of the fastener.

Reducing unsprung mass, which includes components of a vehicle that are not supported by the suspension system such as wheels, tires, brake components, and wheel fasteners, improves vehicle efficiency and dynamics. Further, because wheel fasteners are located at the wheel hub and rotate with the wheel assembly, reductions in fastener mass also contribute to lower rotational inertia. For example, in electric or hybrid vehicles, where vehicle mass and energy efficiency are closely linked, reductions in unsprung and rotating mass may improve driving efficiency and extend vehicle range. The use of the lightweight wheel fasteners 10 can provide both dynamic and efficiency-related benefits without altering the structural requirements of the wheel attachment system or the tools needed for installation.

FIG. 2 illustrates a section view of the lightweight fastener assembly 10 to better show the retention feature 36. As shown, the fastener body 30 includes a first end 32 and a second end 34 opposite the first end 32. The retention feature 36 is formed adjacent the first end 32 and is configured to receive and retain the cap 20 when assembled. The fastener body 30 further includes a load-bearing surface 56 configured to mate with a corresponding fastener seat on a wheel during installation. The load-bearing surface 56 extends to an outer flange 38. The outer flange 38 having a diameter greater than a diameter of the retention feature 36.

The load-bearing surface 56 may be tapered, spherical or frustoconical. When the threads are fully seated at standard torque levels, the load-bearing surface 56 may be compressed and in tension with a corresponding surface to reduce the tendency for the bolt to loosen, thereby maintaining the fastener 10 is securely seated. The fastener body 30 may have a coating, or multi-layer coatings, that provide corrosion resistance and also provide a desired coefficient of friction. For example, the fastener body may have a coating such as described in U.S. patent application Ser. No. 17/716979, the disclosure of which is hereby incorporated in its entirety by reference herein.

A threaded portion 50 extends from the second end 34 of the fastener body 30 and is configured for threaded engagement with a mating stud or threaded aperture. A wrenching feature 40 is formed on the fastener body 30 for engagement by a tool to apply installation or removal torque independently of the cap 20. The wrenching feature 40 is formed between the cap retention feature 36 and the second end 34.

In the embodiment illustrated in FIGS. 1-2, the fastener body 30 is illustrated as a nut. In this configuration, the threaded portion 50 comprises an internal threaded opening 52 formed within the fastener body 30. As shown, the internal threaded opening 52 extends axially through the fastener body 30 from the first end 32 to the second end 34 and has a chamfered lead-in aperture 54 to the internal threaded opening at the first end 32. In alternative embodiments, the fastener body 30 may be configured as a bolt, in which case the threaded portion 50 has external threads extending from the second end 34 for threaded engagement.

As illustrated in FIGS. 1-2, the fastener assembly 10 includes a cap 20 secured to the retention feature 36 of the fastener body 30. The cap 20 includes upright contoured walls 22 extending from an engagement feature 24 to a cap top 26. The contoured walls 22 and the cap top 26 together define a hollow portion 28 of the cap 20 that extends beyond the first end 32 of the fastener body 30 when the cap 20 is secured. The hollow portion 28 reduces the mass of the cap 20 while maintaining the desired external appearance and coverage of the fastener body 30.

As illustrated in FIG. 1-2, the contoured walls 22 of the cap may be shaped to resemble the external profile of a conventional hex fastener for aesthetic compatibility with existing wheel fasteners. However, because the contoured walls 22 do not function as a wrenching surface, the contoured walls 22 may alternatively have other decorative shapes or profiles. For example, the contoured walls 22 may define a three-point fastener profile, a cylindrical shape, a polygonal shape, a curved or faceted profile, or other ornamental or non-standard geometries for appearance or styling purposes.

In one embodiment, the cap 20 is formed of stainless steel and may be polished and not require additional coatings. The cap 20 may also have a decorative coating, such as the black coating as described in International Patent Application No. PCT/US22/22811 by MacLean Fogg Company, the disclosure of which is hereby incorporated by reference herein. The cap 20 may be secured to the fastener body 30 after any coating is applied to the fastener body so the cap does not have a coating or has a coating different than the fastener body. In alternative embodiments, the cap 20 may be formed of other materials. The cap 20 may also have a decorative finish and can be bright, black, variations of colors, and have logos and/or branding etched and/or annealed onto the exposed surfaces. In other embodiments, the cap 20 may be formed of other metallic or non-metallic materials. The cap 20 may also be plated, coated, or have surface finishes for aesthetic, durability, or corrosion-resistance characteristics.

As illustrated in FIG. 2, the cap retention feature 36 on the fastener body 30 includes an annular groove 46 formed in a retention wall 48. The retention wall 48 extends between the first end and a flange 38 formed adjacent the first end 32 of the fastener body. The annular groove 46 extends circumferentially around the fastener body 30 and is configured to engage a corresponding engagement feature 24 of the cap 20. The retention wall 48 and groove 46 have a diameter that is less than a diameter of the first end 32 of the fastener body 30 and less than the flange 38. The annular groove 46 formed in the retention wall 48 allows the cap 20 to be secured to the fastener body 30 without having to extend over and be retained on the flange 38.

The cap 20 includes a retaining lip 44 at the first end 32 of the fastener body 30 above the retention feature 36. The retaining lip 44 is configured to cooperate with the retention feature 36 to secure the cap 20 to the fastener body. In some embodiments, a top surface of the retaining lip 44 is may be generally planar and the lip 44 may have a minimal thickness in the lightweight design.

The cap 20 may be assembled to the fastener body 30 by deforming a lower portion of the cap into the retention feature 36 formed on the fastener body. As described above, the retention feature 36 may comprise an annular groove 46 extending circumferentially around the fastener body 30. During assembly, the engagement feature 24 on the cap 20 is retained in the groove 46. The base portion of the cap 20 is plastically deformed radially inward so that material of the cap 20 engages the retention feature 36. This deformation secures the cap 20 to the fastener body 30.

In one embodiment, the base portion of the cap 20 is plastically deformed radially inward so that material of the cap 20 engages the retention feature 36. This deformation secures the cap 20 to the fastener body 30. The cap 20 may be secured to the fastener body 30 with a continuous crimp extending substantially around the entire circumference of the retention feature 36. Forming a continuous crimp into the annular groove presents manufacturing challenges due to limited access while still ensuring secure engagement. The continuous circumferential crimp may provide secure retention of the cap 20 relative on the fastener body 30. Further, securing the cap 20 to the fastener body 30 using a continuous circumferential crimp along the retention feature 36 provides several structural and functional advantages over attachment methods employing discrete locations. A continuous crimp distributes retention forces uniformly around the circumference of the fastener body, reducing localized stress concentrations that can occur at isolated attachment points. This uniform engagement improves axial retention of the cap, enhances resistance to loosening under vibration and cyclic loading, and promotes consistent concentric alignment of the cap relative to the fastener body. Additionally, forming a continuous circumferential crimp into an annular groove presents manufacturing challenges that differ from discrete crimping operations, including precise control of material flow and deformation around the entire perimeter of the fastener.

In other embodiments, the cap 20 is secured to the retention feature 36 at a plurality of locations spaced around the fastener body 30. Discrete attachment locations may reduce forming complexity while still providing adequate retention. It is further contemplated that the cap 20 may be attached to the retention feature 36 using crimping, swagging, staking, roll-forming or other cold-working or forging process or other suitable mechanical deformation or forming techniques, so that the cap remains securely retained on the fastener body to meet performance requirements.

In other embodiments, the engagement feature 24 may be formed in the cap 20 together with forming the cap. The cap 20 may be secured to the retention feature 36 with an interference fit, such as a press fit or snap fit where the engagement feature elastically deforms as the cap is assembled over the lip 44.

In any of the attachment configurations, the cap 20 may be allowed to rotate relative to the fastener body 30. The cap 20 may spin freely about the fastener body when secured.

Unlike traditional decorative wheel fasteners in which the wrenching surface is formed at or near an outer end of the fastener and is defined by the decorative cap, the wrenching surface 42 of the present fastener assembly 10 is spaced axially inward from the outer distal end of the fastener assembly 10. As shown in the figures, the cap 20 has an outer diameter that is less than a diameter of the wrenching feature 40. This relative sizing allows a tool to access and engage the wrenching feature 40 over and around the cap 20, while the cap 20 remains secured to the fastener body 30. By spacing the wrenching surface 42 away from the outer end and reducing the diameter of the cap, the decorative cap is decoupled from the torque-transmitting function of the fastener.

As illustrated in FIG. 1-2, the wrenching feature 40 may be formed along the flange 38 of the fastener body 30. In the illustrated embodiment, the wrenching feature 40 includes a plurality of flat wrenching surfaces 42 that together define a polygonal profile, such as a hexagonal shape, configured for engagement by a standard wrench or socket. While a hexagonal profile is shown, the wrenching feature 40 may alternatively define other polygonal or standardized tool-engagement geometries, including three-point, double-hex, square, spline, twelve-point drive or other profiles compatible with commonly available tools that allow installation and removal of the fastener using standard tools while providing a lightweight fastener.

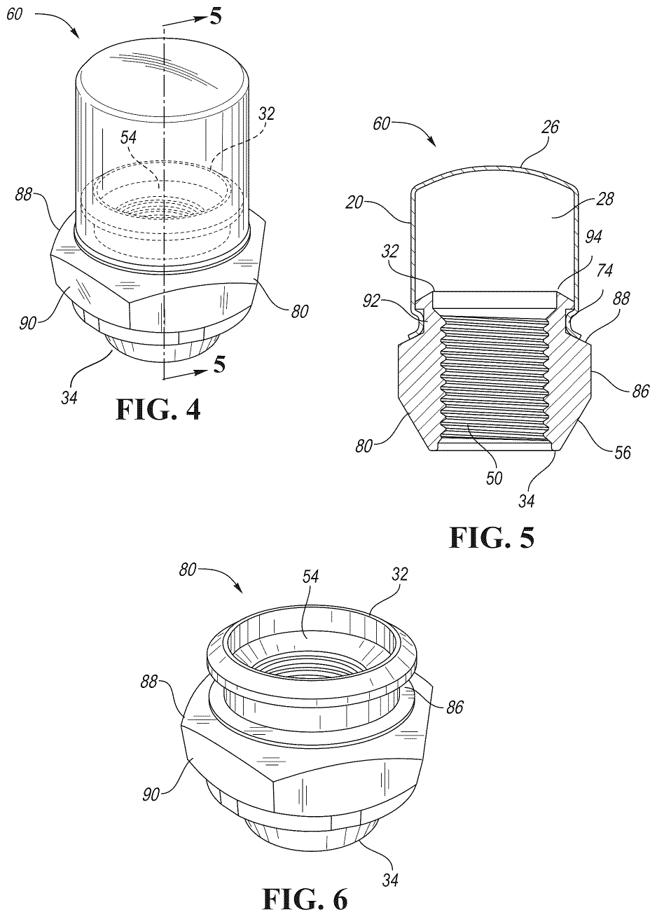

FIG. 4-8 illustrate another alternate embodiment of a lightweight fastener assembly 60 in which the decorative cap has a different external appearance while retaining the same functional relationships described above. In this embodiment, the fastener assembly 60 includes a cap 70 secured to a fastener body 80, wherein the cap 70 has a generally cylindrical outer decorative contour 72. Unless otherwise noted, the fastener assembly 60 includes structures and features that are the same as, or functionally similar to, those described above with respect to the fastener assembly 10 illustrated in FIG. 1-2.

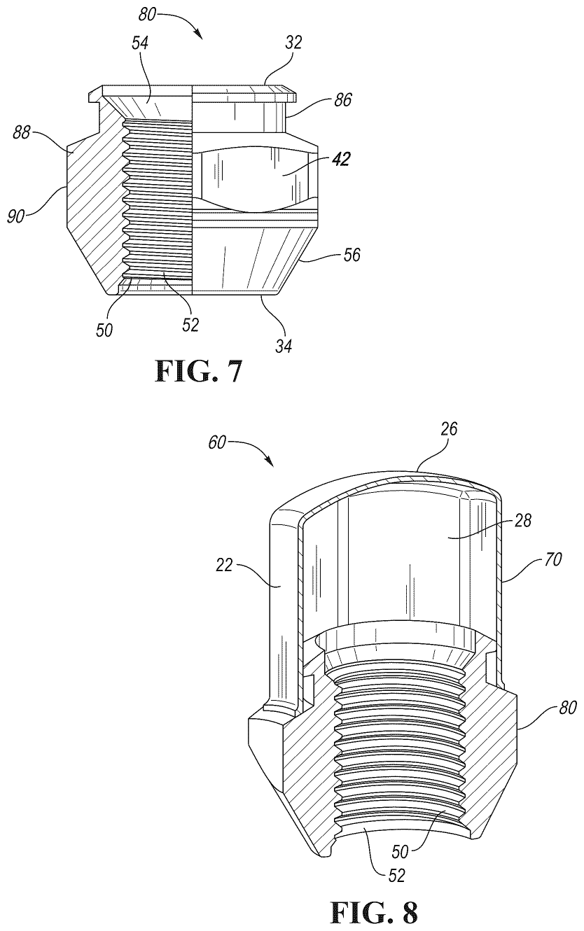

FIGS. 6-7 illustrate the fastener body 80 with the decorative cap removed to show the retention feature 86. As shown, the fastener body 80 includes a first end 32 and a second end 34 opposite the first end 32. A retention feature 86 is formed adjacent the first end 32 and is configured to receive and retain the cap 70 when assembled. The fastener body 80 further includes a load-bearing surface 56 configured to mate with a corresponding fastener seat on a wheel during installation. The load-bearing surface 56 extends to an outer flange 88. The outer flange 88 having a diameter greater than a diameter of the retention feature 86.

A wrenching feature 90 is formed on the flange 88 of fastener body 80 and is configured for engagement by a tool to apply installation or removal torque independently of the cap 70, as described above with respect to the other embodiments.

As illustrated in FIG. 4-8, the cap retention feature 36 on the fastener body 30 includes a retention wall 92 formed adjacent the first end 32 of the fastener body. The retention wall 92 extends circumferentially around the fastener body 30 and forms an undercut area from the lip 94 to engage a corresponding engagement feature 74 of the cap 70. The retention wall 92 has a diameter that is less than a diameter of the first end 32 of the fastener body 30 and less than the flange 88. The flange 88 and wrenching feature 90 may have a smaller diameter compared to the embodiment in FIGS. 1-2, to provide further weight reduction. Similarly, the retention wall 92 may have a smaller diameter compared to the embodiment in FIGS. 1-2.

The cap 70 includes a retaining lip 94 at the first end 32 of the fastener body 30 above the retention feature 36. In some embodiments, a top surface of the retaining lip 94 is tapered downward and outward relative to a central axis of the fastener assembly 60 or may have a truncated conical shape.

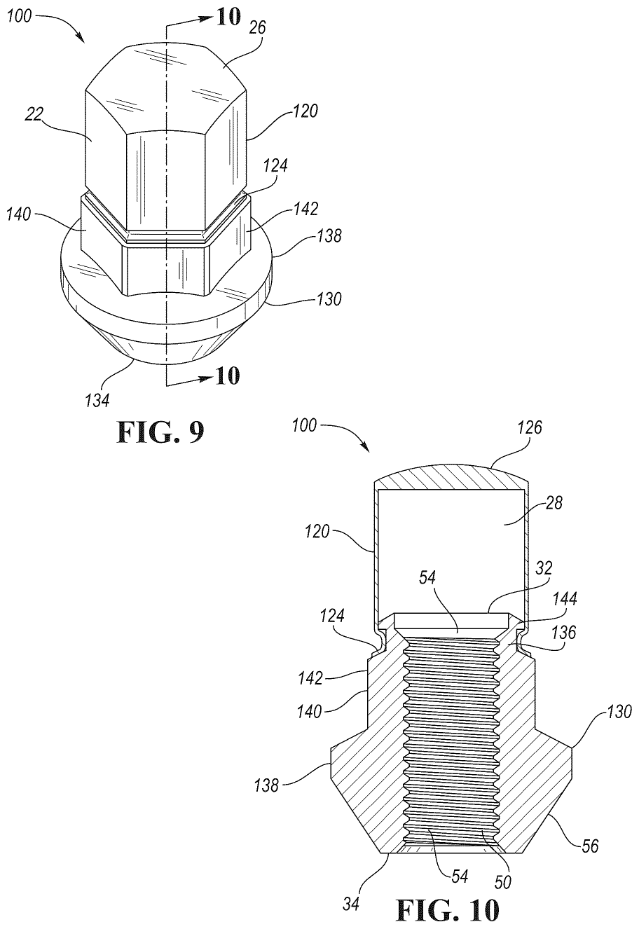

FIGS. 9 and 10 illustrate an alternate embodiment of a lightweight fastener assembly 100 in which the wrenching feature is positioned differently than in the embodiments described above. In this embodiment, a wrenching feature 140 is formed on the fastener body 130 between a flange 138 and a cap retention feature 136, rather than along the flange. This arrangement may provide increased radial and axial clearance for a tool to access the wrenching feature 140 between an opening in a wheel. Unless otherwise noted, the fastener assembly 100 includes structures and features that are the same as, or functionally similar to, those described above with respect to the fastener assembly in FIGS. 1-2 and 4-8. The fastener assembly 100 includes a cap 120 secured to the fastener body 130, the cap 120 providing a decorative exterior while remaining structurally independent of the wrenching function of the fastener body.

The fastener body 130 includes a first end 32 and a second end 34 opposite the first end 32. A retention feature 136 is formed adjacent the first end 32 and includes a wall or groove 148 configured to retain the cap 120. A load-bearing surface 56 is formed toward the second end 34 and is configured to mate with a corresponding fastener seat on a wheel. A threaded portion 50 extends from the second end 34 and, in the illustrated embodiment, comprises an internal threaded opening 52 extending axially through the fastener body 130 and having a chamfered lead-in aperture 54 at the first end 32.

In the embodiment illustrated in FIGS. 9 and 10, a wrenching feature 140 is formed on the fastener body 130 between the retention feature 136 and a flange 138. This arrangement differs from the embodiments described above in which the wrenching feature is formed along the flange. In this embodiment, the wrenching feature 140 is positioned axially between the flange 138 and the retention feature 136, thereby further separating the wrenching function from the decorative cap 120. The wrenching feature 140 includes one or more flat wrenching surfaces 142 configured for engagement by a tool.

As shown, the wrenching feature 140 has an outer diameter that is less than an outer diameter of the flange 138. In this embodiment, the flange 138 and load-bearing surface 56 are sized to maintain a load-bearing interface with the fastener seat, while the wrenching feature 140 remains accessible to a tool positioned radially inward of the flange. In some embodiments, the flange 138 may be reduced in size or minimized to further reduce mass.

The cap 120 includes upright contoured walls 122 extending from an engagement feature 124 to the cap top 26. The contoured walls 22 and the cap top 26 define a hollow portion 28 that extends beyond the first end 32 of the fastener body 130 when assembled. A retaining lip 144 is formed at the first end 32 of the fastener body and cooperates with the retention feature 136 to secure the cap 120 to the fastener body 130. The structures, materials, attachment methods, and functional relationships of the fastener assembly 100 may be the same as those described above with respect to the other embodiments.

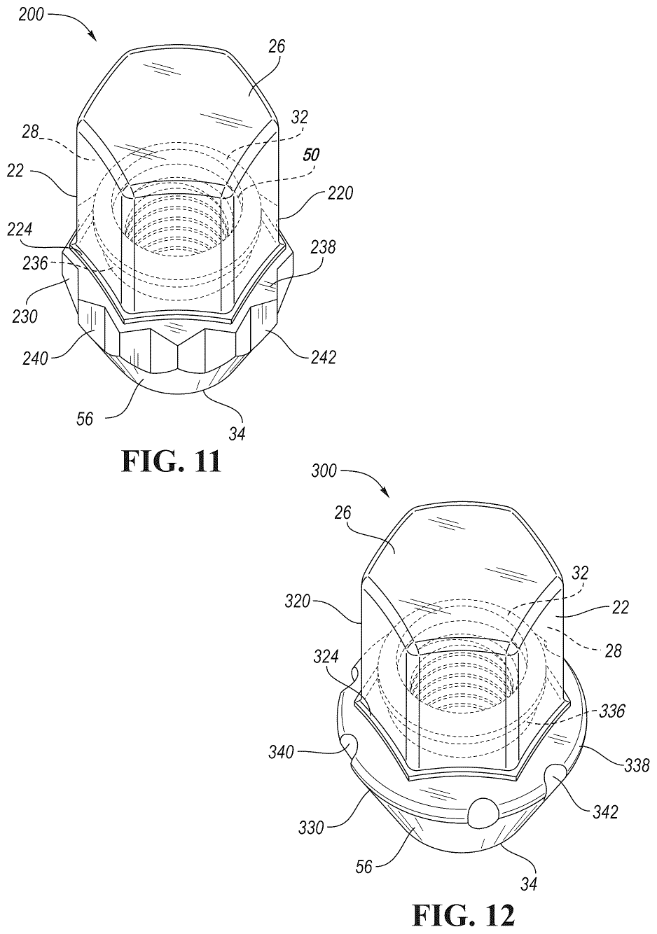

FIG. 11 illustrates another alternate embodiment of a lightweight fastener assembly 200 in which the wrenching feature is configured as a multi-point wrenching surface. Unless otherwise noted, the fastener assembly 200 includes structures and features that are the same as, or functionally similar to, those described above with respect to the fastener assemblies illustrated in FIGS. 1-2 and 4-10. The fastener assembly 200 includes a cap 220 secured to a fastener body 230, the cap 220 providing a decorative exterior while remaining structurally independent of the wrenching function of the fastener body.

The fastener body 30 includes a first end 32 and a second end 34 opposite the first end 32. A retention feature 236 is formed adjacent the first end 32 and is configured to retain the cap 220. A load-bearing surface 56 is formed toward the second end 34 and is configured to mate with a corresponding fastener seat on a wheel. A threaded portion 50 extends from the second end 34 and, in the illustrated embodiment, comprises an internal threaded opening 52 extending axially through the fastener body 230.

In the embodiment illustrated in FIG. 11, a wrenching feature 240 is formed on the fastener body 230 along a flange 238. The wrenching feature 240 comprises a multi-point drive feature 242, such as a 12-point wrenching surface, configured for engagement by a corresponding tool having a mating multi-point profile. The multi-point drive feature 242 allows torque to be applied at a greater number of angular orientations relative to the fastener body 230 compared to a standard hexagonal profile, which may facilitate tool engagement in confined spaces. The wrenching feature 240 has a diameter larger than the cap 220, allowing the tool to engage the fastener body without the cap transmitting installation or removal torque.

The cap 220 includes upright contoured walls 22 extending from an engagement feature 224 to the cap top 26. The contoured walls 22 and the top cap 26 define a hollow portion 28 that extends beyond the first end 32 of the fastener body 230 when assembled. The structures, materials, attachment methods, and functional relationships of the fastener assembly 200 may be the same as those described above with respect to the other embodiments.

FIG. 12 illustrates another alternate embodiment of a lightweight fastener assembly 300 in which the wrenching feature is configured as a spline drive. Unless otherwise noted, the fastener assembly 300 includes structures and features that are the same as, or functionally similar to, those described above with respect to the fastener assemblies illustrated in FIGS. 1-2 and 4-11. The fastener assembly 300 includes a cap 320 secured to a fastener body 330, the cap 320 providing a decorative exterior while remaining structurally independent of the wrenching function of the fastener body.

The fastener body 330 includes a first end 32 and a second end 34 opposite the first end 32. A retention feature 36 is formed adjacent the first end 32 and is configured to retain the cap 320. A load-bearing surface 56 is formed toward the second end 34 and is configured to mate with a corresponding fastener seat on a wheel. A threaded portion 50 extends from the second end 34 and, in the illustrated embodiment, comprises an internal threaded opening 52 extending axially through the fastener body 330.

In the embodiment illustrated in FIG. 12, a wrenching feature 340 is formed on the fastener body 330 along a flange 338. The wrenching feature 340 comprises a spline drive wrenching surface 342 including a plurality of rounded or radiused grooves extending generally in an axial direction and spaced evenly about the flange 338. The spline drive wrenching surface 342 is configured for engagement by a standard spline wrench or spline socket. The spline drive configuration may provide a greater number of tool-engagement surfaces and engagement orientation compared to a conventional hex profile, which may facilitate tool access in confined spaces. As illustrated, the spline drive wrenching surface 342 is formed on the flange 338 and remains spaced apart from the cap 320, allowing the application of installation or removal torque without requiring the cap 320 to transmit torque or be structurally reinforced for wrenching.

The cap 320 includes upright contoured walls 22 extending from an engagement feature 324 to the cap top 26. The contoured walls 22 and the cap top 26 define a hollow portion 28 that extends beyond the first end 32 of the fastener body 330 when assembled. A retaining lip 344 is formed at the first end 32 of the cap 320 and cooperates with the retention feature 336 to secure the cap 320 to the fastener body 330.

Unless otherwise indicated, the individual features, structures, and functional relationships described in connection with the various embodiments of the fastener assemblies may be applied in other embodiments disclosed herein where technically feasible and compatible. In particular, features described with respect to one embodiment may be used in combination with features of another embodiment to form further embodiments, provided that such combinations do not result in technical incompatibility. Accordingly, alternative embodiments may include selected combinations of the disclosed cap configurations, retention features, attachment methods, wrenching features, materials, and decorative contours, without departing from the underlying principles of the present disclosure. Such combinations are considered to be directly and unambiguously derivable from the present description by a person skilled in the art.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lightweight fastener assembly comprising:
a fastener body having:
a cap retention feature adjacent a first end;
a threaded portion extending from a second end;
a load bearing surface configured to mate with a fastener seat on a wheel;
a flange formed adjacent a load bearing surface and having a diameter larger than the cap retention feature;
a wrenching feature formed between the cap retention feature and the second end;
a cap secured to the cap retention feature on the fastener body and has upright contoured walls extending to a cap top, wherein the cap is hollow in a capped region defined by the contoured walls and cap top beyond the first end of the fastener body.

2. The lightweight fastener assembly of claim 1, wherein the wrenching feature is formed along the flange.

3. The lightweight fastener assembly of claim 1, wherein the wrenching feature is formed between the flange and the cap retention feature.

4. The lightweight fastener assembly of claim 1, wherein the cap has a diameter less than the wrenching feature.

5. The lightweight fastener assembly of claim 1, wherein the cap does not cover the flange and spins freely about the fastener body when secured to the retention feature.

6. The lightweight fastener assembly of claim 1, wherein the wrenching feature comprises a polygonal wrenching surface for engagement by a standard tool.

7. The lightweight fastener assembly of claim 1, wherein the wrenching feature comprises a spline drive feature.

8. The lightweight fastener assembly of claim 1, wherein the fastener body comprises a nut body and the threaded portion comprises an internal threaded opening extending from the second end.

9. The lightweight fastener assembly of claim 8, wherein the internal threaded opening has an aperture that extends through the fastener body from the first end to the second end.

10. The lightweight fastener assembly of claim 1, wherein the cap retention feature on the fastener body comprises a retention wall having a diameter less than the first end.

11. The lightweight fastener assembly of claim 10, wherein the cap is secured to the fastener body with continuous crimp along a circumference of the retention wall.

12. The lightweight fastener assembly of claim 11, wherein the retention wall further comprises an annular groove.

13. A lightweight fastener assembly comprising
a fastener body having:
a cap retention feature adjacent a first end; and
a threaded portion at a second end;
a wrenching surface formed between the first end and the second end, the wrenching surface; and
a cap secured to the retention feature, wherein the cap is hollow in a capped region that extends beyond the first end of the fastener body.

14. The lightweight fastener assembly of claim 13, wherein the fastener body comprises a flange formed adjacent a load bearing surface having a diameter larger than the cap retention feature.

15. The lightweight fastener assembly of claim 14, wherein the cap does not cover the flange.

16. The lightweight fastener assembly of claim 13, wherein the cap is circumferentially crimped to the fastener body along the retention feature.

17. The lightweight fastener assembly of claim 13, wherein the cap has a diameter less than the wrenching feature.

18. The lightweight fastener assembly of claim 1, wherein the cap spins freely about the fastener body when secured to the retention feature.

19. A method comprising:
forming a fastener body having a cap retention feature adjacent a first end and a threaded portion extending from a second end, wherein a standard wrenching surface is formed between the cap retention feature and the second end;
forming a cap; and
securing an engagement feature on the cap to the retention feature on the fastener body,
wherein the cap does not cover a wrenching surface on the fastener body.

20. The method of claim 19, further comprising forming the fastener body the wrenching surface being a greater diameter than the cap.
